(19) United States
(12) Patent Application Publication
(10) Pub. No.: US 2022/0042135 A1
(43) Pub. Date: Feb. 10, 2022

(54) ORIENTED ELECTRICAL STEEL SHEET AND MANUFACTURING METHOD THEREOF

(71) Applicant: POSCO, Pohang-si, Gyeongsangbuk-do (KR)

(72) Inventors: Kyu-Seok Han, Pohang-si, Gyeongsangbuk-do (KR); Chang Soo Park, Pohang-si, Gyeongsangbuk-do (KR); Seung Il Kim, Pohang-si, Gyeongsangbuk-do (KR); Joo Young Koo, Pohang-si, Gyeongsangbuk-do (KR); Jae Kim, Pohang-si, Gyeongsangbuk-do (KR); Seon Young Yu, Pohang-si, Gyeongsangbuk-do (KR)

(21) Appl. No.: 17/415,814

(22) PCT Filed: Oct. 31, 2019
(86) PCT No.: PCT/KR2019/014623

§ 371 Date: Jun. 18, 2021

(30) Foreign Application Priority Data
Dec. 19, 2018 (KR) 10-2018-0165663

(51) Int. Cl. C21D 9/46; C21D 8/12; C21D 6/00; C22C 38/60; C22C 38/44; C22C 38/42; C22C 38/06; C22C 38/04; C22C 38/02; C22C 38/00; H01F 1/147

(52) U.S. Cl. CPC C21D 9/46; C22C 2202/02; C21D 8/1233; C21D 8/1261; C21D 8/1283; C21D 8/1255; C21D 6/008; C21D 6/005; C21D 6/004; C22C 38/60; C22C 38/44; C22C 38/42; C22C 38/06; C22C 38/04; C22C 38/02; C22C 38/008; C22C 38/002; C22C 38/001; H01F 1/147; C21D 8/1222

(57) ABSTRACT

An oriented electrical steel sheet according to an exemplary embodiment of the present invention includes C: 0.01% or less (excluding 0%), Si: 2.0%-4.0%, Mn: 0.01%-0.20%, acid soluble Al: 0.040% or less (excluding 0%), N: 0.008% (excluding 0%), S: 0.008% (excluding 0%), Se: 0.0001-0.008%, Cu: 0.002-0.1%, Ni: 0.005-0.1%, Cr: 0.005-0.1%, P: 0.005%-0.1% and Sn: 0.005%-0.20%, one or more among Sb: 0.0005%-0.10%, Ge: 0.0005%-0.10%, As: 0.0005%-0.10%, Pb: 0.0001%-0.10%, Bi: 0.0001%-0.10% and Mo: 0.001-0.1% as wt %, and consisting of the balance of Fe and other inevitable impurities, and after final secondary recrystallization, a magnetic flux density B8 is 1.92 Tesla or more.

### TECHNICAL FIELD

The present disclosure relates to an oriented electrical steel sheet and a manufacturing method thereof. More specifically, the present disclosure relates to an oriented electrical steel sheet and a manufacturing method thereof, which further improves a magnetic flux density by controlling a composition of a steel sheet and forming a crystal orientation with an excellent integration degree by controlling a rolling condition during hot rolling at the same time.

### BACKGROUND ART

Since the oriented electrical steel sheet is used as an iron core material for electronic products such as large rotating machines such as transformers and generators, in order to improve energy conversion efficiency by reducing a power loss of the electronic devices, a magnetic flux density of the iron core material is high and an iron loss is excellent, thereby a magnetically excellent electrical steel sheet is required. The grain-oriented electrical steel sheet refers to a functional material having a texture (referred to as a “Goss texture”) of which a secondary-recrystallized grain is oriented with an azimuth {110}<001> in a rolling direction through a hot rolling process, a cold rolling process, and an annealing process. As an orientation of all grains on the steel sheet surface is a {110} plane, and the crystal orientation of the rolling direction is formed of a Goss texture parallel to the <001> axis, this oriented electrical steel sheet is a very good soft magnetic material. In general, the magnetic characteristics of the electrical steel sheet may be expressed in terms of the magnetic flux density and the iron loss, and high magnetic flux density may be obtained by accurately arranging the grain orientation in the {110}<001> orientation. The electrical steel sheet with high magnetic flux density not only reduces the size of the iron core material of an electric device, but also lowers a hysteresis loss, thereby enabling down-sizing of the electric equipment and high efficiency at the same time. The iron loss is a power loss consumed as heat energy when a random AC magnetic field is applied to the steel sheet and varies greatly depending on the magnetic flux density and sheet thickness of the steel sheet, the amount of impurities in the steel sheet, a specific resistance, and a secondary recrystallization grain size, as the higher the magnetic flux density and the specific resistance, and the lower the plate thickness and the amount of impurities in the steel sheet, the lower the iron loss, thereby the efficiency of the electric device increases. In order to manufacture the oriented electrical steel sheet with excellent magnetic characteristic like this, the steel sheet must be strongly formed in the texture of the {110}<001> orientation into the rolling direction of the steel sheet, and in order to form such a texture, it is important to very strictly control the entire manufacturing process for each processing unit, such as the composition of the steel sheet, the heating condition of the slab, the hot rolling, hot rolled sheet annealing, primary recrystallization annealing, and final annealing for the secondary recrystallization. In order to manufacture the oriented electrical steel sheet, it is necessary to form a growth suppressor (hereinafter, referred to as “a suppressing agent”) to suppress the growth of the primary recrystallization grains, and it is necessary to control the grains having the texture of the {110}<001> orientation to be grown preferentially (hereinafter, referred to as “a secondary recrystallization”) among the grains whose growth was suppressed in the final annealing process. These suppressing agents are fine precipitates or segregated elements, and are thermally stable up to a high temperature just before the secondary recrystallization occurs, and then grow or decompose when the temperature is higher, and the secondary recrystallized particles preferentially and rapidly grow in a relatively short time. Currently widely used suppressing agents include MnS, AlN, and MnSe(Sb). First, when MnS was used as a grain growth suppressing agent and the oriented electrical steel sheet was manufactured through cold rolling and high temperature annealing twice, the magnetic flux density (a magnetic flux density at B8, 800 A/m) was 1.80 Tesla, and the iron loss was relatively high. And when AIN and MnS precipitates were used in combination as a grain growth suppressing agent, and the oriented electrical steel sheet was manufactured by the cold rolling once with a cold rolling rate of 80% or more, a method of manufacturing the oriented electrical steel sheet exhibiting the magnetic flux density B8 up to 1.87 Tesla or higher is known. However, this level of the magnetic flux density is still in need of the improvement compared to a theoretical saturation magnetic flux density of 2.03 Tesla of the oriented electrical steel sheet including 3% Si, and responding to the recent demand for the transformer high efficiency and down-sizing, it is necessary to improve the magnetic flux density. As a conventional magnetic flux density improvement technology, there is a technology that has proposed the manufacturing method of the oriented electrical steel sheet having the magnetic flux density B8 of 1.95 Tesla or more by temperature gradient annealing during high temperature annealing. However, this method is a high energy loss and inefficient manufacturing method because it has to be heated from one side of the coil in terms of the mass production process where high temperature annealing is performed in the coil state of 10 tons or more by weight, therefore it is not implemented in the actual production line. As another magnetic flux density improvement method, a manufacturing method is known in which a product with the magnetic flux density B8 of 1.95 Tesla or more is obtained by adding a Bi-containing material to the molten steel of the oriented electrical steel sheet component series using AlN and MnS precipitates. However, all of these technologies are component series using a combination of AlN and MnS precipitates, and in order to efficiently use these precipitates, a heat treatment that completely solidifies the precipitate by heating the slab containing the AlN and MnS precipitate forming elements to 1300° C. or higher was needed. This heat treatment may be seen as a high-cost, low-efficiency manufacturing method in which the energy cost increases due to slab high temperature heating and slab washing such that the slab melts and edge cracks occur during the hot rolling at high temperature, thereby deteriorating a real yield. In addition, it is possible to secure a high magnetic flux density characteristic through the addition of Bi, however most of the previously proposed patents focusing on problems that the surface and the secondary recrystallization are unstably formed due to the main addition of Bi were proposed as various improvement ideas in the post-hot rolling process in order to overcome such side effects, and it is difficult to produce stably in the actual manufacturing process and a lot of trial and error are required.

### DISCLOSURE

### Description of the Drawings

An oriented electrical steel sheet and a manufacturing method are provided.

More specifically, it aims to provide an oriented electrical steel sheet and a manufacturing method thereof, which further improves magnetic characteristics by controlling a composition of a steel sheet and forming a crystal orientation with an excellent integration degree by controlling a rolling condition during hot rolling and cold rolling at the same time.

An oriented electrical steel sheet according to an exemplary embodiment of the present invention includes C: 0.01% or less (excluding 0%), Si: 2.0%-4.0%, Mn: 0.01%-0.20%, acid soluble Al: 0.040% or less (excluding 0%), N: 0.008% (excluding 0%), S: 0.008% (excluding 0%), Se: 0.0001-0.008%, Cu: 0.002-0.1%, Ni: 0.005-0.1%, Cr: 0.005-0.1%, P: 0.005%-0.1% and Sn: 0.005%-0.20%, one or more among Sb: 0.0005%-0.10%, Ge: 0.0005%-0.10%, As: 0.0005%-0.10%, Pb: 0.0001%-0.10%, Bi: 0.0001%-0.10% and Mo:0.001-0.1% as wt %, and consisting of the balance of Fe and other inevitable impurities, and after final secondary recrystallization, a magnetic flux density B8 is 1.92 Tesla or more.

An orientation difference (α²+β²)^{1/2} with an exact {110}<001> Goss texture for a secondary recrystallization grain after the final secondary recrystallization of the oriented electrical steel sheet according to an exemplary embodiment of the present invention is 4° or less.

A manufacturing method of an electrical steel sheet according to another exemplary embodiment of the present invention includes preparing a slab including C: 0.01% or less (excluding 0%), Si: 2.0%-4.0%, Mn: 0.01%-0.20%, acid soluble Al: 0.040% or less (excluding 0%), N: 0.008% (excluding 0%), S: 0.008% (excluding 0%), Se: 0.0001-0.008%, Cu: 0.002-0.1%, Ni: 0.005-0.1%, Cr: 0.005-0.1%, P: 0.005%-0.1% and Sn: 0.005%-0.20%, one or more among Sb: 0.0005%-0.10%, Ge: 0.0005%-0.10%, As: 0.0005%-0.10%, Pb: 0.0001%-0.10%, Bi: 0.0001%-0.10%, and Mo:0.001-0.1% as wt %, and consisting of the balance of Fe and other inevitable impurities; heating the slab below 1280° C.; performing hot rolling and hot rolled sheet annealing to the heated slab to manufacture a hot rolled sheet; @@@manufacturing a cold rolled sheet by cold rolling and intermediate annealing the hot rolled sheet; heating the cold-rolled sheet to a temperature of 600° C. or higher at a temperature increasing rate of 20° C./sec or higher to perform a decarburization annealing and nitriding treatment for primary recrystallization; and applying an annealing separator including MgO as a main component to finally anneal the primary recrystallized steel sheet for secondary recrystallization, wherein rough rolling is performed with a cumulative reduction ratio of 60% or more and rough rolling with a reduction ratio of 20% or more is performed once or more in the slab rough rolling before the hot rolling, and the hot rolling is performed.

It is preferable that decarburization annealing and nitridation treatments are performed in the primary recrystallization step so as to ensure a total nitrogen content of the steel sheet of 0.01-0.05%.

It is preferable that the rough rolling of which the cumulative reduction ratio is 70% or more is performed in the slab rough rolling.

It is preferable that the cold rolling is performed in the temperature range of 150-300° C. during the cold rolling.

It is preferable that the cold-rolled sheet is heated to a temperature of 600° C. or higher with a heating rate of 50° C./sec or higher in the primary recrystallization annealing.

According to one embodiment of the present invention, the excellent oriented electrical steel sheet having the high magnetic flux density of 1.92 Tesla or more may be obtained by precisely controlling the composition of the electrical steel sheet and increasing the cumulative reduction ratio in the hot rolling.

According to one embodiment of the present invention, an oriented electrical steel sheet with high Goss orientation integration, of which the orientation of the secondary recrystallization grain after the final secondary recrystallization has the orientation difference (deviation angle, °) (α²+β²)^{1/2} of 4° or less with the exact (exact) {110}<001>, may be obtained.

According to one embodiment of the present invention, since the magnetic flux density is high, the oriented electrical steel sheet having the excellent magnetic characteristics may be manufactured, and the electronic device using this oriented electrical steel sheet as an iron core material has the excellent magnetic characteristics.

### Mode for Invention

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section described below could be termed a second element, component, region, layer, or section without departing from the teachings of the present invention.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and “comprising”, when used in this specification, specify the presence of stated features, integers, steps, operations, elements, and/or components, but do not preclude the presence or addition of one or more other features, integers, steps, operations, elements, components, and/or groups.

It will be understood that when an element such as a layer, film, region, or substrate is referred to as being “on” or “above” another element, it can be directly on or above the other element or intervening elements may also be present. In contrast, when an element is referred to as being “directly on” another element, there are no intervening elements therebetween.

If not defined differently, all the terminologies including the technical terminologies and scientific terminologies used herein have meanings that are the same as ones that those skilled in the art generally understand. The terms defined in dictionaries should be construed as having meanings corresponding to the related prior art documents and those stated herein, and are not to be construed as being ideal or official, if not so defined.

Hereinafter, exemplary embodiments of the present invention will be described in detail so as to be easily practiced by a person skilled in the art to which the present invention pertains. As those skilled in the art would realize, the described embodiments may be modified in various different ways, all without departing from the spirit or scope of the present invention.

In manufacturing an oriented electrical steel sheet according to an exemplary embodiment of the present invention, a manufacturing method for improving the magnetic flux density characteristic is as follows.

First, in order to manufacture an oriented electrical steel sheet with excellent magnetic flux density, it is necessary to form a large number of grains having an exact Goss texture, which is a core of the secondary recrystallization, in the steel sheet.

In order to make a lot of the grains of the exact Goss texture, it is necessary to control processing conditions in advance so that a lot of Goss texture grains may occur from the initial deformation after slab manufacturing.

At this time, elements such as P, Sn, Sb, Ge, As, Pb, and Bi among the composition of the steel sheet are segregated at grain boundaries to reduce a deformation resistance of grains during rough rolling, thereby suppressing the recrystallization of orientations other than Goss.

Eventually, there are many Goss texture grains in the steel sheet after the rough rolling and the hot rolling, and it becomes the basis for manufacturing the oriented electrical steel sheet with the excellent magnetic flux density to when high temperature annealing for the steel sheet is performed after the cold rolling.

Further, in addition to the method of increasing the Goss texture grain by adding the grain boundary segregation element, when it is rolled over a certain reduction rate during high temperature deformation such as the rough rolling, a shear deformation occurs, and as a result, many grains having the Goth texture, which are the shear deformation aggregated structures, exist in the steel sheet.

When the steel sheet is deformed in a high temperature range of 1000° C. or higher, dynamic recovery or dynamic recrystallization occurs. As the amount of the deformation increases, the deformation energy is concentrated at the grain boundary, in the case that the temperature is sufficiently high, the phenomenon that the deformation energy concentrated at the grain boundary naturally disappears is called dynamic recovery, and a phenomenon that the recrystallization phenomenon by the deformation energy concentrated at the grain boundary is continuous during the deformation process is called dynamic recrystallization.

In an exemplary embodiment of the present invention, in the rough rolling step with the addition of grain boundary segregation elements, the rough rolling with one reduction ratio of 20% or more is performed once or more, and when the cumulative reduction ratio is 60% or more, the magnetic flux density is better than 1.92 Tesla after the final high temperature annealing.

For this, as a result that inventors studied the correlation between the grain boundary segregation element and the rough rolling reduction ratio, a lot of the grains in the Goss texture occur due to the high temperature shear deformation during the rough rolling with one reduction ratio of 20% or more, and since the deformation resistance at the grain boundary by the added grain boundary segregation element was reduced and the dynamic recovery was performed without the dynamic recrystallization to other orientations other than the Goss, there were many Goss texture grains in the steel sheet. Therefore, finally, after high temperature annealing, a high magnetic flux density characteristic of 1.92 Tesla or more may be secured.

Meanwhile, this excellent high magnetic flux density characteristic is ultimately determined by how well the secondary recrystallized Goss texture grains are arranged in a most ideal 110}<001> orientation.

As a method for evaluating the orientation of this secondary recrystallized Goss grain, first, there is a method for evaluating the difference from the exact {110}<001> orientation by measuring an orientation difference (a deviation angle, °) α for a normal direction (ND) to the rolling surface of the steel sheet, an orientation difference (a deviation angle, °) β for a rolling vertical direction (TD), and an orientation difference (a deviation angle, °) γ in a rolling direction (RD).

Among them, the orientation difference (deviation angle, °) that has the greatest influence on the magnetic flux density is α and β, and these orientation differences ultimately become the standard capable of evaluating how far the <001> axis of the secondary recrystallization grain is out from the rolling direction.

In other words, for the products with high magnetic flux density of 1.92 Tesla or higher, it means that the crystal orientation of the secondary recrystallized grains has a small crystal orientation difference α and β for the exact {110}<001> Goss orientation. As a method to evaluate this more quantitatively, it may be expressed by the following equation.

An orientation difference for the exact {110}<001> crystallization orientation: (α²+β²)^{1/2} [Equation 1]

That is, it means that the smaller the (α2 β2)½ value for the exact {110}<001> crystallization orientation of the secondary recrystallized Goss grain orientation, the higher the magnetic flux density.

For the oriented electrical steel sheet according to an exemplary embodiment of the present invention, as the result for measuring the secondary recrystallization grain orientation of the oriented electrical steel sheet manufactured to ensure the high magnetic flux density characteristic of 1.92 Tesla or more, it was confirmed the orientation difference for the exact {110}<001> crystallization orientation is less than about 4°.

Hereinafter, the reasons for limiting the components of the oriented electrical steel sheet according to an exemplary embodiment of the present invention described above (% of the component elements in the present invention all mean wt % unless otherwise stated) will be described in detail.

First, C as an element that promotes an austenite phase transformation is an element making the hot-rolled structure of the oriented electrical steel sheet uniform and promoting the grain formation of the Goss orientation during the cold rolling, so that it is an important element in manufacturing the oriented electrical steel sheet with the excellent magnetism. This effect may be seen only when C is added at at least 0.01%, and the secondary recrystallization is unstable due to the non-uniform hot-rolled structure at a lower content. However, if more than 0.10% is added, the first recrystallization grain becomes fine due to the formation of the fine hot-rolled structure due to the austenite phase transformation during the hot rolling, a coarse carbide may be formed in the cooling process after a winding process or the hot rolled sheet annealing after the hot rolling is finished, and a cementite (Fe₃C) is formed at room temperature, so it is easy to cause a non-uniformity to the organization. Therefore, it is desirable to limit the content of C in the slab to 0.01-0.10%.

However, the content of C decreases due to decarburization generated during the first recrystallization process. In addition, when a large amount of C remains in the final manufactured oriented electrical steel sheet, it is an element that deteriorates the magnetic characteristics by precipitating the carbide formed in the steel sheet due to the magnetic aging effect. Therefore, it is preferable to include the C content of 0.01 wt % or less (excluding 0%) in the final manufactured oriented electrical steel sheet. More specifically, C may be included in an amount of 0.005 wt % or less. More specifically, C may be included in an amount of 0.003 wt % or less.

Si is the basic composition of the oriented electrical steel sheet, which increases the specific resistance of the material, thereby lowering the iron core loss, that is, the iron loss. When the Si content is less than 2.0%, the specific resistance decreases and the iron loss characteristic is deteriorated, and the secondary recrystallization becomes unstable due to the presence of a phase transformation section during high temperature annealing, when it is included at more than 4.0%, brittleness of the steel becomes large and the cold rolling becomes extremely difficult. Therefore, Si is limited to 2.0-4.0%. Specifically, Si may be included in an amount of 3.0-4.0%.

Mn has the effect of reducing the iron loss by increasing the specific resistance like Si, and it is used as a suppressing agent to suppress the growth of the primary recrystallization grains by reacting with S and Se to form Mn[S,Se] precipitates. In the present invention, if more than 0.200% is added, the suppression power decreases because the Mn[S,Se] precipitate becomes coarse, and the slab needs to be heated to a high temperature to solutionize the Mn[S,Se] precipitate. On the contrary, in order to control to less than 0.01%, the burden of refining in steelmaking increases, and the effect as a suppressing agent decreases due to the formation of less Mn[S,Se] precipitation, so the content of Mn is limited to 0.01-0.20%. Specifically, the content of Mn may be included at 0.05 to 0.15%.

S generally reacts with Mn to form a MnS precipitate and acts as a suppressing agent to suppress the growth of the primary recrystallization grain. In the present invention, since the MnS precipitate is used as a crystal growth suppressing agent together with the AlN precipitate, a particularly large amount is not added. If more than 0.008% of S is added, the suppressing power is weakened as the MnS precipitate becomes coarse, and there is a drawback in which the precipitate is not completely dissolved when the slab is heated. On the contrary, if it is added below 0.004%, the MnS precipitate is very small and the effect as a suppressing agent decreases, therefore, the content of S in the slab in the present invention is limited to 0.004-0.008%.

However, since S has a process of forming or decomposing precipitates during the product manufacturing process, it is desirable to include the S content as 0.008 wt % or less (excluding 0%) in the final manufactured oriented electrical steel sheet.

Se generally reacts with Mn to form MnSe precipitates and acts as a suppressing agent to suppress the growth of primary recrystallization grains. In the present invention, since the MnSe precipitate together with AIN and MnS is used as a crystal growth suppressing agent, a particularly large amount is not added. If more than 0.008% of Se is added, the suppression power is weakened as the MnSe precipitate becomes coarse, and there is a drawback in which the precipitate is not completely dissolved when the slab is heated. On the contrary, if it is added to 0.0001% or less, the MnSe precipitate is very small and the effect as a suppressing agent decreases. Therefore, the content of Se in the present invention is limited to 0.0001-0.008%. Specifically, the content of Se may be included at 0.001-0.008%. More specifically, the content of Se may be included at 0.005-0.008%.

Cu combines S and Se in the steel to form a Cu[S,Se] precipitate, thereby suppressing the grain growth. The crystal growth suppressing power is stronger because it precipitates finely faster than the Mn[S,Se] precipitate. In order to secure such crystal growth suppressing power, the amount of Cu added is more than 0.002%, and if less than that, the formation of Cu[S,Se] precipitates is small, it difficult to secure the suppressing power, and on the contrary, if it is increased by 0.1% or more, the coarse Cu[S,Se] precipitate increases, and the crystal growth suppressing power also decreases. Therefore, it is preferable to limit the content of Cu in the present invention to 0.002-0.1%. Specifically, Cu may be included in an amount of 0.005-0.07%. More specifically, Cu may be included in an amount of 0.01-0.07%.

Al is a member of the representative grain growth suppressing agent for forming the secondary recrystallization of the oriented electrical steel sheet by bonding with N in steel to form AIN. In the present invention, it is preferable to add 0.010-0.040% of Al in the steelmaking step because the Al-based nitride is formed through a nitriding process in the primary recrystallization annealing process to secure the grain growth suppression effect. If the Al content is less than 0.010%, the total amount of the Al-based precipitate formed during the primary recrystallization and the nitriding process is insignificant, and the suppressing power of the primary recrystallization grain growth is insufficient, and on the contrary, in the case of 0.040% or more, as the precipitate grows coarse in the slab manufacturing and hot rolling process, the grain growth suppressing power is deteriorated, and thus the magnetic characteristics of high magnetic flux density cannot be secured. Therefore, the Al content in the slab is limited to 0.010-0.040%.

However, since Al has the process of forming or decomposing the precipitate during the product manufacturing process, it is desirable to include it at 0.040 wt % or less (excluding 0%) of the Al content in the final manufactured oriented electrical steel sheet.

N is an important element that reacts with Al to form AIN, which suppresses the growth of the recrystallization grains, but when the content of N is added at more than 0.008%, in the slab manufacturing and hot rolling steps, the formation of the AIN precipitate increases, thereby interfering with the primary recrystallization and crystal growth, and resultantly the primary recrystallization microstructure is non-uniform, making it difficult to secure the high magnetic flux density characteristic. Conversely, adding less than 0.001% increases the load on the refining process of the steelmaking, and the grain growth is promoted during the primary recrystallization, thereby it is difficult to secure a uniform primary recrystallization microstructure, and a high magnetic flux density characteristic may not be secured. Therefore, the content of N in the steelmaking step is limited to 0.001-0.008%. Specifically, the content of N may be included at 0.003-0.008%. More specifically, the content of N may be included at 0.005-0.008%. However, it is desirable to include the N content of 0.008 wt % or less (excluding 0%) in the final manufactured oriented electrical steel sheet in the process in which N forms or decomposes the precipitate during the product manufacturing process.

Ni is an alloy element that promotes the formation of austenite, and it is important to make the uniform hot rolled microstructure by promoting the phase transformation with C. In addition, during the hot rolling process, it promotes the formation of the Goss texture of the {110}<001> orientation, which is a shear deformation Goss texture that is important for securing the high magnetic flux density characteristic. Therefore, if more than 0.005% of Ni should be added, {110}<001> Goss texture may be promoted, and in contrast, if more than 0.1% is added, the {110}<001> Goss texture is well formed, but the formation of an oxide layer on the surface of the steel sheet is interfered with, resulting in deterioration of the surface quality of the final product. Therefore, in the present invention, it is preferable to limit the Ni addition amount to 0.005-0.1%. Specifically, the content of Ni may be included at 0.005-0.08%. More specifically, the content of Ni may be included at 0.005-0.05%.

Mo promotes the formation of the {110}<001> orientation Goss texture, which is a shear deformation Goss texture that is important for securing high magnetic flux density characteristics during the hot rolling. In addition, it has the effect of suppressing the occurrence of the surface crack during the hot rolling by suppressing the grain boundary oxidation at a high temperature. If more than 0.001% of Mo should be added, the formation of the {110}<001> Goss texture may be promoted, and conversely, if more than 0.1% of Mo is added, the {110}<001> Goss texture is well formed, since it is an expensive alloy iron, the additive effect is inferior compared to the magnetic flux density improvement. Therefore, in the present invention, it is preferable to limit the added amount of Mo to 0.001-0.1%. Specifically, the content of Mo may be included at 0.003-0.07%.

Cr is an important element for stabilizing the unstable formation of the surface oxide layer due to the addition of a segregation element, which is a characteristic of the present invention, by reacting with oxygen most quickly in the decarburization annealing process to form Cr₂O₃ on the surface of the steel sheet. In general, since the segregation element tends to segregate not only the grain boundary but also the surface, before the decarburization and the surface oxide layer formation by the segregation element are suppressed, the decarburization reaction is smoothly performed by first forming Cr₂O₃ in the surface layer. If such Cr is added at 0.005% or less, there is no effect of the addition, and if it is added at 0.1% or more, it does not have a significant effect on the formation of the surface oxide layer, and accordingly the preferred Cr addition amount is limited to 0.005-0.1%. Specifically, the content of Cr may be included at 0.01-0.08%.

P is a key grain boundary segregation element of the present invention, and may play a role of suppressing the grain growth that hinders the movement of the grain boundary, and has an effect of improving the {110}<001> Goss texture. If the content of P is less than 0.005%, there is no effect of the addition, and if more than 0.100% is added, brittleness increases and a rollability is greatly deteriorated, and therefore, it is preferable to be limited to 0.005-0.100%. Specifically, the content of P may be included at 0.005-0.07%.

Sn is one of the important segregation elements of the present invention, and the effect of segregating at the grain boundary and preventing the movement of the grain boundary acts as an excellent auxiliary grain growth suppressing agent. In addition, it is stably present in the grain boundary even at a high temperature and does not have a significant effect on the decarburization and the surface oxide layer formation. In addition, it promotes the grain generation of Goss orientation during the hot rolling, thereby helping to develop the excellent magnetic secondary recrystallization. In the present invention, if Sn is less than 0.005%, the adding effect is insignificant, and conversely, if more than 0.200% is added, the grain boundary and surface segregation occurs severely, so that the load of the decarburization process gradually increases, and the possibility of a plate fracture during the cold rolling increases. Therefore, the Sn content is limited to 0.005-0.20%. Specifically, the content of Sn may be included at 0.005-0.08%. More specifically, Sn may be included at 0.005-0.04%.

Sb is one of the important segregation elements of the present invention, and is an excellent element that has the effect of preventing the movement of the grain boundary by segregating at the grain boundary. In addition, by controlling the depth of the oxide layer inside the steel sheet formed during the decarburization process, a magnetic movement is suppressed by the formation of the internal oxide layer, thereby minimizing an increase in the iron loss. In the present invention, when the content of Sb is less than 0.0005%, the addition amount is very small, so the addition effect may not be obtained, and on the contrary, when adding more than 0.100%, a cold rolling plate fracture and a decarburization delay, which are the same problems as with Sn, occur, therefore, the Sb content in the steelmaking step is limited to 0.0005-0.10%. Specifically, Sb may be included at 0.001-0.05%.

Ge is one of the important segregation elements of the present invention, and the effect of segregating at the grain boundary and preventing the movement of the grain boundary acts as an excellent auxiliary grain growth suppressing agent. In addition, it promotes the grain formation of Goss orientation during the hot rolling, thereby helping to develop the excellent magnetic secondary recrystallization. In the present invention, when Ge is less than 0.0005%, the adding effect is insignificant, and when more than 0.10% is added, the decarburization load increases and the magnetic flux density improvement characteristic is inferior to the addition effect. Therefore, the Ge content is limited to 0.0005-0.10%.

As is also one of the important segregation elements of the present invention along with Ge, it has an excellent effect of interfering with the movement of the grain boundaries by the segregation to the grain boundary, and promotes the grain formation in the Goss orientation during the hot rolling, thereby helping the secondary recrystallization of the excellent magnetism to be well developed. In the present invention, when the As content is less than 0.0005%, the adding effect is insignificant, and when 0.10% or more is added, the decarburization load increases, and the magnetic flux density improvement characteristic is inferior to the addition effect. Therefore, the As content is limited to 0.0005-0.10%.

Pb, along with Sn, Sb, As, and Ge, is one of the important segregation elements of the present invention. It has an excellent effect of interfering with the movement of the grain boundaries by being segregated at the grain boundaries, thereby helping to well develop the secondary recrystallization of the excellent magnetism. In the present invention, when the Pb content is less than 0.0001%, the adding effect is insignificant, whereas when 0.10% or more is added, the decarburization load increases and the magnetic flux density improvement effect decreases. Therefore, the Pb content is limited to 0.0001-0.10%.

Bi is one of the important segregation elements of the present invention along with Pb, Sn, Sb, As, and Ge. It has an excellent effect of interfering with the movement of the grain boundary by being segregated at the grain boundary, and in addition, it promotes the grain formation of the Goss orientation during the hot rolling, helping to well develop the excellent magnetic secondary recrystallization. In the present invention, when the Bi content is less than 0.0001%, the adding effect is insignificant, and on the contrary, when the Bi content is less than 0.0001%, the surface segregation increases and the decarburization load increases, and the oxide layer formation becomes unstable, resulting in increasing the surface defects. Therefore, the Bi content is limited to 0.0001-0.10%.

In the present invention, since the segregation elements such as P, Sn, Sb, As, Ge, Pb, and Bi are effective in improving the magnetic flux density by increasing the Goss orientation grain in the primary recrystallization, and also suppressing the growth of the primary grain, it is desirable to add at least one or more kinds of the segregation elements in combination.

Next, the manufacturing method of the oriented electrical steel sheet according to an exemplary embodiment of the present invention is described in detail.

First, a slab having the composition described above is prepared. If the components are adjusted in the component range as described above, during the process of the slab manufacturing and the hot rolling, the secondary recrystallization of the Goss orientation grain is promoted by suppressing the crystal growth of the primary recrystallization grain by the formation of the precipitates of AlN, Mn[S,Se], and Cu[S,Se], the stress concentration at the grain boundary in the transformation process is reduced due to the grain boundary segregation of the P, Sn, Sb, As, Ge, Pb, and Bi elements, and a lot of Goss orientation grains in the primary recrystallization structure are recrystallized by promoting the formation of Goss orientation grains by the shear deformation, thereby improving the magnetic flux density.

In addition, Ni and Mo promote the growth of Goss orientation grains during the hot rolling through solid solution strengthening and prevent the formation of the oxide layer due to preventing the grain boundary segregation from becoming unstable through the addition of Cr.

For the oriented electrical steel sheet according to an exemplary embodiment of the present invention, in the method of manufacturing the hot rolled sheet from the steel making, a crushing method, a continuous casting method, and a thin slab casting or strip casting are possible. Hereinafter, a method of manufacturing the hot rolled sheet using the slab is mainly described.

The slab having the above-described composition is charged into a heating furnace and then heated at 1280° C. or less. Specifically, the slab is heated at 1100 to 1280° C. The hot rolling is performed using the heated slab.

In the hot rolling process, the heated slab is subjected to the rough rolling and the finish rolling at a high temperature of 900° C. or higher to be rolled to a thickness of 1.0-3.5 mm, which is an appropriate thickness for the cold rolling.

In the hot rolling process, structural shear deformation occurs due to a slab thickness and a rolling roll diameter, and accordingly, Goss orientation grains are formed in the shear deformation structure. In addition to the fundamental shear deformation mechanism of the hot rolling process, the grain formation of Goss orientation is further promoted by the addition of the solid solution strengthening elements and grain boundary segregation elements described above.

In addition, the amount of the deformation varies greatly depending on the rolling rate during the rough rolling and hot rolling, which has a great influence on the formation of Goss orientation grain. Moreover, when the rough rolling condition is controlled (i.e., when a large rolling rate is given) so that the shear deformation becomes large during the deformation of a material having a thick thickness of the initial rolling such as the rough rolling, the formation of the Goss orientation grain is greatly promoted.

The reduction ratio during the hot rolling is described in more detail.

In order to hot-roll the heated slab to a thickness of 1.0-3.5 mm, it is rolled to a thickness suitable for hot rolling through the rough rolling of several times. It is preferable to roughly roll the slab into a bar from a heated thickness to a thickness of 30 mm or more, and at this time, the rough rolling is performed at least one rolling to produce the bar. At this time, it was confirmed that the Goss texture greatly developed due to the shear deformation when the rolling rate of 20% or more of at least one or more times is rolled. Specifically, the rolling rate of at least one or more times may be 20 to 40%.

Also, when the rough rolling is performed with the cumulative reduction rate of the rolling from the slab to the bar thickness of at least 60% or more. In the final primary recrystallization microstructure, the Goss orientation grain increased, and when the high temperature annealing process was followed, the magnetic flux density characteristic was superior to 1.92 Tesla or more. More preferably, the cumulative reduction ratio in the rough rolling step is 70% or more. Specifically, the cumulative reduction rate in the rough rolling step may be 60 to 80%.

In the case of the rough rolling in the hot rolling, when the one-time rolling rate was less than 20%, the amount of the shear deformation was small, resulting in less formation of Goss orientation grains. On the contrary, the higher the rolling rate, the greater the shear deformation, which is very helpful in the formation of the Goss orientation, however since the load of the equipment of the rough rolling is greatly increased, by considering the capability of the facility, it is desirable to manufacture the bar by performing the rough rolling of at least once with the reduction ratio of 20% or more and then to performing the final hot rolling.

After performing the rough rolling by the above method to produce the Bar, the hot rolling is performed with a thickness of 1.0-3.5 mm, but generally, it is performed such that the rolling is terminated at a temperature of 850° C. or higher in consideration of the rolling load, then the cooling is performed at the temperature of 600° C. or less for winding.

For the steel sheet in which the hot rolling is completed, the hot-rolled deformed structure is recrystallized in the hot rolled sheet annealing process afterwards, thereby making the rolling smoothly to the final product thickness in the cold rolling process, which is a later process. It is preferable that the hot rolled sheet annealing temperature is heated to a temperature of 800° C. or higher for the recrystallization and maintained for a certain period of time, and for forming AIN, Mn[S,Se], and Cu[S,Se] precipitates and controlling the size, annealing for heating with a plurality of temperatures is possible.

The hot rolled sheet that has undergone such a hot rolled sheet annealing process is subjected to acid pickling to remove the oxide layer on the steel sheet surface, and then the cold rolling is performed.

The cold rolling is a process of lowering the thickness of the steel sheet to the final product thickness, and in the present invention, the cold rolling is performed once or more than once including intermediate annealing to be rolled to the final product thickness. At this time, the cold rolling rate reinforces the density of the Goss orientation and affects the magnetic flux density improvement after the final secondary recrystallization annealing, so it is desirable to perform the cold rolling with a rolling rate of at least 80%.

If the cold rolling rate is less than 80%, the density of the Goss texture is low and the magnetic flux density of the final product decreases. Therefore, the cold rolling rate should be at least 80%, and the maximum rolling rate may be rolled up to the maximum rollable range according to the rolling capacity of the rolling facility.

In addition, if the temperature of the cold-rolled steel sheet is raised to 150° C. or higher in the cold rolling process, the secondary recrystallization nuclei of Goss orientation are generated a lot due to work hardening by a solid solution carbon, which may improve the magnetic flux density of the final product. If the temperature of the cold-rolled steel sheet is less than 150° C., the secondary recrystallization nuclei generation of Goss texture is insignificant, and on the contrary, when the temperature of the cold-rolled steel sheet is higher than 300° C., the work hardening effect by the solid solution carbon is weakened, resulting in weakening of the secondary recrystallization nuclei in the Goss texture. Therefore, in the cold rolling process, it is desirable to maintain the steel sheet in the temperature range of 150-300° C. at least once in the intermediate rolling step.

Next, after the cold-rolled steel sheet undergoes a rolling oil removal process, the AIN precipitate with a uniform primary recrystallization microstructure of an appropriate grain size and a strong crystal growth suppression power is formed through the primary recrystallization and simultaneously through the decarburization and nitriding processes.

At this time, the cold-rolled steel sheet must be heated to a temperature of 600° C. or higher with a temperature increase rate of 20° C./sec or higher, so the first recrystallization of the Goss orientation grain, which was increased by the addition of the segregation elements and the rough rolling of more than 20% once in the previous process, may be promoted. At this time, it is more preferable to heat the cold-rolled sheet at a temperature of 600° C. or higher at a temperature increase rate of 50° C./sec or higher. Specifically, the cold-rolled sheet may be heated at a temperature increase rate of 20 to 200° C./sec at a temperature of 600 to 900° C.

When the temperature rise rate is less than 20° C./sec, the recrystallization of the Goss orientation grains is delayed due to the recovery of the tissues deformed by the cold rolling, and the fraction of the Goss orientation grains decreases after the first recrystallization.

Therefore, in the case of the primary recrystallization annealing of the cold rolling plate, it is preferable to increase the temperature at an increasing rate of 20° C./sec or higher to the decarburization and recrystallization temperature range of 600° C. or higher. In addition, it is necessary to suppress the crystal growth of the primary recrystallization grain by forming the AlN precipitate in the steel sheet through the nitriding treatment using ammonia along with decarburization annealing.

At this time, the total nitrogen content in the nitriding-treated steel sheet is preferably limited to 0.01-0.05% range. If the total nitrogen content is less than 0.01%, the total amount of AlN precipitate formed through nitriding treatment is too small, thereby it is difficult to secure the desired crystal growth suppression force, resulting in unstable secondary recrystallization, and it is difficult to secure the magnetic flux density of 1.92 Tesla or more.

On the contrary, when the total nitrogen content is increased to 0.05% or more, the secondary recrystallization is not well formed in which the crystal growth is excessively increased due to the excessive AlN formation. In addition, when the excess nitrogen is decomposed in the steel sheet in the high temperature range of 1100° C. or higher, it causes surface defects such as nitrogen outlets on the steel sheet surface. Therefore, it is preferable to perform the nitriding treatment by limiting the total nitrogen content to the 0.01-0.05% range.

As the decarburized and nitriding-treated steel sheet is then coated with an annealing separator based on MgO, and then heated to 1000° C. or higher and crack-annealed for a long time to cause the secondary recrystallization, the Goss texture of the Goss orientation, of which the {110} surface of the steel sheet is parallel to the rolling surface and the <001> direction is parallel to the rolling direction, is formed, and the electrical steel sheet with the excellent oriented magnetic characteristic is manufactured.

For the oriented electrical steel sheet manufactured under the conditions as described above, the strong crystal growth suppression power is secured by using the AIN, Mn[S,Se], and Cu[S,Se] precipitates and simultaneously the formation of the Goss orientation grain is promoted by the grain boundary segregation effect of P, Sn, Sb, As, Ge, Pb, and Bi elements and the increasing of the shear deformation due to the addition of Ni and Mo.

In addition, in the rough rolling process after the slab heating, by performing the rough rolling having a one-time rolling rate of 20% or more at least once so that the total cumulative reduction rate is 60% or more, the formation of the Goss orientation grains by the increasing of the shear deformation amount is promoted to produce the bar, this was hot-rolled and then cold-rolled into the final product thickness, and then heated to the temperature range of 600° C. or higher with the temperature increasing rate of 20° C./sec or higher for the decarburization and primary recrystallization, and simultaneously the nitriding treatment was performed to adjust the total nitrogen content in the steel sheet to the range of 0.01-0.05% and the crystallization orientation of the secondary recrystallized Goss orientation grain after the final high temperature annealing was measured, as a result, the orientation difference for the exact {110}<001> crystallization orientation was about 4° or less.

Therefore, the oriented electrical steel sheet manufactured according to an exemplary embodiment of the present invention exhibited the excellent magnetic characteristic with the magnetic flux density of 1.92 Tesla or higher.

Hereinafter, the present invention is described in more detail through exemplary embodiments. However, these exemplary embodiments are only for exemplifying the present invention, and the present invention is not limited thereto.

### Exemplary Embodiment 1

As shown in Table 1 below, a steel component system using C, Si, Mn, acid soluble Al, N, S, Se, Cu, Ni, Cr, and Mo as the basic composition changing the contents of P, Sn, Sb, Ge, As, Pb, and Bi was vacuum-dissolved to make a cast steel.

This cast steel was heated to a temperature of 1150° C., and then a 40 mm bar was manufactured through the rough rolling six times, next hot-rolled to a thickness of 2.3 mm, and then is rapidly cooled to 600° C. for winding.

At this time, the rough rolling was performed 1, 2, and 3 times at a rolling rate of 20% or more, and the rough rolling was performed with the total cumulative reduction rate of 60% or more.

This hot-rolled steel sheet was subjected to a hot rolled sheet annealing at 1050° C., and then acid pickling was performed, and then steel-cold-rolled once to a thickness of 0.23 mm.

The cold-rolled steel sheet was heated to 850° C. at a heating speed of 50° C./sec, and then maintained for 180 seconds in a mixed gas atmosphere of humid hydrogen, nitrogen, and ammonia for the primary recrystallization annealing. In this way, the nitriding treatment was simultaneously performed so that the total nitrogen content of the steel sheet was 200 ppm during the primary recrystallization annealing.

Subsequently, an annealing separator including MgO as a main component was applied to the steel sheet to perform secondary recrystallization high temperature annealing in a form of a coil.

The high-temperature annealing was performed in a mixed gas atmosphere of 25% N₂ and 75% H₂ until 1200° C., and after reaching 1200° C., it was kept in a 100% H₂ gas atmosphere for 20 hours and then slowly cooled.

Table 1 shows measurement results of a magnetic flux density B8 and an iron loss characteristic (W17/50) after the secondary recrystallization high temperature annealing for each alloy component system. In addition, an orientation difference (a deviation angle, °) (α²+β²)^{1/2} with the exact {110}<001> orientation was measured for the orientation of the secondary recrystallized grain through Laue diffraction measurement.

TABLE 1

| C | Si | Al | Mn | Cu | Cr | Ni | Mo | S | Se | N | P | Sn | Sb |
|---|---|---|---|---|---|---|---|---|---|---|---|---|---|
| 0.038 | 3.28 | 0.025 | 0.1 | 0.03 | 0.02 | 0.05 | 0.01 | 0.005 | 0.005 | 0.0042 | 0.004 | 0.004 | — |
| 0.045 | 3.22 | 0.028 | 0.08 | 0.02 | 0.01 | 0.02 | 0.005 | 0.0045 | 0.003 | 0.0031 | 0.005 | 0.005 | — |
| 0.055 | 3.84 | 0.035 | 0.05 | 0.01 | 0.05 | 0.03 | 0.03 | 0.0055 | 0.006 | 0.0055 | 0.005 | 0.005 | 0.0 [symbol] 1 |
| 0.048 | 3.61 | 0.029 | 0.15 | 0.05 | 0.04 | 0.02 | 0.05 | 0.007 | 0.001 | 0.0063 | 0.005 | 0.005 | — |
| 0.058 | 3.36 | 0.032 | 0.12 | 0.07 | 0.08 | 0.05 | 0.07 | 0.008 | 0.002 | 0.0051 | 0.005 | 0.005 | |
| 0.072 | 3.55 | 0.035 | 0.04 | 0.03 | 0.03 | 0.04 | 0.005 | 0.0042 | 0.007 | 0.0077 | 0.005 | 0.005 | |
| 0.078 | 3.68 | 0.033 | 0.07 | 0.01 | 0.02 | 0.007 | 0.003 | 0.0052 | 0.006 | 0.0048 | 0.006 | 0.02 | 0.0 [symbol] 1 |
| 0.054 | 3.39 | 0.031 | 0.13 | 0.005 | 0.01 | 0.02 | 0.005 | 0.0059 | 0.002 | 0.0041 | 0.015 | 0.005 | 0.0 [symbol] 5 |
| 0.049 | 3.18 | 0.021 | 0.05 | 0.07 | 0.04 | 0.01 | 0.01 | 0.0075 | 0.0065 | 0.0064 | 0.03 | 0.03 | 0.0 [symbol] |
| 0.052 | 3.01 | 0.015 | 0.15 | 0.05 | 0.08 | 0.05 | 0.03 | 0.0077 | 0.0077 | 0.0075 | 0.07 | 0.04 | 0.0 [symbol] |
| 0.081 | 3.85 | 0.035 | 0.05 | 0.03 | 0.01 | 0.08 | 0.05 | 0.0055 | 0.0015 | 0.004 | 0.03 | 0.08 | 0.0 [symbol] |
| 0.03 | 2.9 | 0.033 | 0.13 | 0.04 | 0.05 | 0.02 | 0.03 | 0.0043 | 0.0009 | 0.0041 | 0.03 | 0.04 | 0.0 [symbol] |
| 0.056 | 3.31 | 0.03 | 0.09 | 0.02 | 0.04 | 0.01 | 0.03 | 0.0052 | 0.0058 | 0.0044 | 0.03 | 0.04 | 0.0 [symbol] |
| 0.055 | 3.35 | 0.029 | 0.11 | 0.03 | 0.03 | 0.03 | 0.01 | 0.0045 | 0.0059 | 0.0049 | 0.03 | 0.04 | 0.0 [symbol] |
| 0.035 | 3.15 | 0.026 | 0.12 | 0.02 | 0.02 | 0.01 | 0.01 | 0.0063 | 0.0074 | 0.0071 | 0.03 | 0.04 | 0.0 [symbol] |
| 0.057 | 3.38 | 0.032 | 0.08 | 0.01 | 0.06 | 0.005 | 0.005 | 0.005 | 0.006 | 0.0048 | 0.03 | 0.04 | 0.0 [symbol] |
| 0.039 | 3.18 | 0.025 | 0.15 | 0.05 | 0.04 | 0.01 | 0.02 | 0.0063 | 0.0071 | 0.0051 | 0.03 | 0.04 | 0.0 [symbol] |
| 0.048 | 3.05 | 0.022 | 0.05 | 0.07 | 0.03 | 0.02 | 0.01 | 0.0067 | 0.0078 | 0.0045 | 0.03 | 0.04 | 0.0 [symbol] |
| 0.05 | 3.14 | 0.024 | 0.08 | 0.05 | 0.01 | 0.01 | 0.007 | 0.0073 | 0.0058 | 0.0064 | 0.03 | 0.04 | 0.0 [symbol] |
| 0.062 | 3.48 | 0.031 | 0.1 | 0.01 | 0.04 | 0.05 | 0.009 | 0.0052 | 0.0028 | 0.0048 | 0.03 | 0.04 | 0.0 [symbol] |

[symbol]

indicates data missing or illegible when filed

As confirmed in Table 1 above, when the contents of P, Sn, Sb, Ge, As, Pb, and Bi are added, it may be confirmed that the orientation difference (a deviation angle, °) (α²+β²)^{1/2} with the exact {110}<001> orientation for the orientation of the secondary recrystallization grain was less than 4.0°, and the magnetic flux density of 1.92 Tesla or more may be stably secured.

In addition, when one or more of these components were added in combination to the oriented electrical steel sheet, excellent magnetic flux density characteristics were secured compared to 1.92 Tesla.

### Exemplary Embodiment 2

The slab prepared by vacuum melting and having the composition of inventive material 12 evaluated in exemplary embodiment 1 was heated at 1200° C.

The heated slab was subjected to the rough rolling by changing the number of the rough rollings and the reduction ratio, and then a hot rolled sheet with a thickness of 2.6 mm was manufactured by the hot rolling.

This hot rolled steel sheet was subjected to a hot rolled sheet annealing at 1080° C., acid-pickled, and then cold-rolled once to a thickness of 0.30 mm.

The cold-rolled steel sheet is heated to 860° C. at a heating speed of 30° C./sec, and then maintained for 150 seconds in a mixed gas atmosphere of humid hydrogen, nitrogen, and ammonia to form a primary recrystallization while simultaneously performing a nitriding treatment so that the content of the total nitrogen of the steel sheet was 180 ppm.

Subsequently, an annealing separator including MgO as a main component was applied to the steel sheet, and the final high temperature annealing was performed for the secondary recrystallization in a form of a coil.

The high-temperature annealing was performed in a mixed gas atmosphere of 25% N₂ and 75% H₂ until 1200° C., and after reaching 1200° C., it was kept in a 100% H₂ gas atmosphere for 20 hours and then slowly cooled.

Table 2 shows results of measuring an orientation difference (a deviation angle, °) (α²+β²)^{1/2} with the exact {110}<001> orientation, a magnetic flux density B8, and an iron loss characteristic (W17/50) for a secondary recrystallization grain after secondary recrystallization high temperature annealing depending on the number of the rough rollings and one time reduction rate.

TABLE 2

| | | | | | | | | | | | | Mag- | | |
|---|---|---|---|---|---|---|---|---|---|---|---|---|---|---|
| | | | | | | | | | Cumulative | | | netic | | |
| | | | | | | | | | reduction | | | flux | iron | |
| Rough | | | | | | | | | rate | | (α² + β²)^{1/2} | density | loss | |
| rolling | RM 1 | RM 2 | RM 3 | RM 4 | RM 5 | RM 6 | RM 7 | RM 8 | (%) | | (°) | (Tesla) | (W/kg) | |
| 250 mm | 214 mm | 174 mm | 150 mm | 130 mm | 110 mm | 90 mm | 74 mm | | 60 mm | 76.0% | 4.7 | 1.900 | 1.085 | Comparative |
| Rolling | 14.4% | 18.7% | 13.8% | 13.3% | 15.4% | 18.2% | 17.8% | | 18.9% | | | | | material 1 |
| rate | | | | | | | | | | | | | | |
| 250 mm | 210 mm | 170 mm | 140 mm | 115 mm | 95 mm | 80 mm | 65 mm | | 55 mm | 78.0% | 4.5 | 1.905 | 1.051 | Comparative |
| Rolling | 16.0% | 19.0% | 17.6% | 17.9 % | 17.4% | 15.8 % | 18.8% | | 15.4% | | | | | material 2 |
| rate | | | | | | | | | | | | | | |
| 250 mm | 195 mm | 170 mm | 140 mm | 115 mm | 95 mm | 80 mm | 65 mm | | 55 mm | 78.0% | 3.9 | 1.932 | 0.981 | Inventive |
| Rolling | 22.0% | 12.8% | 17.6% | 17.9% | 17.4% | 15.8 % | 18.8% | | 15.4% | | | | | material 1 |
| rate | | | | | | | | | | | | | | |
| 250 mm | 205 mm | 170 mm | 140 mm | 110 mm | 90 mm | 75 mm | 65 mm | | 55 mm | 78.0% | 3.7 | 1.938 | 0.977 | Inventive |
| Rolling | 18.0% | 17.1% | 17.6% | 21.4% | 18.2% | 16.7% | 13.3% | | 15.4% | | | | | material 2 |
| rate | | | | | | | | | | | | | | |
| 250 mm | 210 mm | 175 mm | 145 mm | 120 mm | 100 mm | 85 mm | 65 mm | | 55 mm | 78.0% | 3.5 | 1.934 | 0.953 | Inventive |
| Rolling | 16.0% | 16.7% | 17.1% | 17.2% | 16.7% | 15.0% | 23.5% | | 15.4% | | | | | material 3 |
| rate | | | | | | | | | | | | | | |
| 250 mm | 220 mm | 185 mm | 155 mm | 130 mm | 110 mm | 85 mm | 65 mm | | 55 mm | 78.0% | 3.5 | 1.938 | 0.950 | Inventive |
| Rolling | 12.0% | 15.9% | 16.2% | 16.1% | 15.4% | 22.7% | 23.5% | | 15.4% | | | | | material 4 |
| rate | | | | | | | | | | | | | | |
| 250 mm | 214 mm | 174 mm | 133 mm | 105 mm | 80 mm | 60 mm | | | | 76.0% | 3.5 | 1.947 | 0.941 | Inventive |
| Rolling | 14.4% | 18.7% | 23.6% | 21.1% | 23.7% | 25.1% | | | | | | | | material 5 |
| rate | | | | | | | | | | | | | | |
| 250 mm | 200 mm | 160 mm | 120 mm | 80 mm | 60 mm | | | | | 76.0% | 3.4 | 1.953 | 0.925 | Inventive |
| Rolling | 20.0% | 20.0% | 25.0% | 33.3% | 25.0% | | | | | | | | | material 6 |
| rate | | | | | | | | | | | | | | |
| 250 mm | 170 mm | 120 mm | 80 mm | 60 mm | | | | | | 76.0% | 3.5 | 1.958 | 0.917 | Inventive |
| Rolling | 32 mm % | 29.4% | 33.3% | 25.0% | | | | | | | | | | material 7 |
| rate | | | | | | | | | | | | | | |
| 200 mm | 165 mm | 135 mm | 110 mm | 90 mm | 73 mm | 60 mm | | | | 70.0% | 4.1 | 1.918 | 0.989 | Comparative |
| Rolling | 17.5% | 18.2% | 18.5% | 18.2% | 18.9% | 17.8% | | | | | | | | material 3 |
| rate | | | | | | | | | | | | | | |
| 160 mm | 135 mm | 110 mm | 90 mm | 73 mm | 60 mm | 50 mm | | | | 68.8% | 4.1 | 1.917 | 0.994 | Comparative |
| Rolling | 15.6% | 18.5% | 18.2% | 18.9% | 17.8% | 16.7% | | | | | | | | material 4 |
| rate | | | | | | | | | | | | | | |
| 140 mm | 110 mm | 90 mm | 80 mm | 70 mm | 60 mm | | | | | 57.1% | 4.3 | 1.911 | 0.997 | Comparative |
| Rolling | 21.4% | 18.2% | 11.1% | 12.5 % | 14.3% | | | | | | | | | material 5 |
| rate | | | | | | | | | | | | | | |
| 100 mm | 80 mm | 65 mm | 50 mm | 40 mm | 35 mm | | | | | 65.0% | 3.9 | 1.925 | 0.964 | Inventive |
| Rolling | 20.0% | 18.8% | 23.1% | 20.0% | 12.5% | | | | | | | | | material 8 |
| rate | | | | | | | | | | | | | | |
| 100 mm | 90 mm | 75 mm | 65 mm | 55 mm | 50 mm | 45 mm | | | | 55.0% | 4.4 | 1.909 | 1.008 | Comparative |
| Rolling | 10.0% | 16.7% | 13.3% | 15.4% | 9.1% | 10.0% | | | | | | | | material 6 |
| rate | | | | | | | | | | | | | | |
| 150 mm | 100 mm | 75 mm | 65 mm | 55 mm | 50 mm | | | | | 66.7% | 3.8 | 1.928 | 0.943 | Inventive |
| Rolling | 33.3% | 25.0% | 13.3% | 15.4% | 9.1% | | | | | | | | | material 9 |
| rate | | | | | | | | | | | | | | |

As shown in Table 2 above, when the rough rolling reduction rate for one time is less than 20%, or when the cumulative reduction rate is less than 60%, the orientation difference (the deviation angle, °) (α²+β²)^{1/2} with the exact {110}<001> orientation of the secondary recrystallized grain orientation was more than 4°, and the excellent magnetic flux density of 1.92 Tesla or more is also difficult to obtain.

### Exemplary Embodiment 3

The slab prepared by vacuum melting with the composition of invention material 8 evaluated in the exemplary embodiment 1 was heated at 1130° C.

In performing the rough rolling of a total 6 times for the heated slab, a reduction ratio of 20% or more is applied at the time of the rough rolling of 3, 4, 5, and 6 times, and the rough rolling is performed with a cumulative reduction ratio of 76.0% to produce a 60 mm bar, and it was hot-rolled to a thickness of 2.3 mm.

This hot rolled steel sheet was subjected to a hot rolled sheet annealing at 1100° C., acid-pickled, and then cold-rolled once to a thickness of 0.23 mm.

The rolling is performed to the final product thickness by changing the rolling temperature to 50-350° C. during the cold rolling, and then the cold-rolled steel sheet is heated up to 855° C. at a temperature rising speed of 70° C./sec and maintained for 180 seconds in a mixed gas atmosphere of a humid hydrogen, nitrogen, and ammonia atmosphere for forming the primary recrystallization while simultaneously performing a nitriding treatment so that the total nitrogen content of the steel sheet was 220 ppm.

Subsequently, an annealing separator including MgO as a main component was applied to the steel sheet, and secondary recrystallization high temperature annealing was performed in a form of a coil.

The high-temperature annealing was performed in a mixed gas atmosphere of 50% N₂ and 50% H₂ until 1200° C., and after reaching 1200° C., it was kept in a 100% H₂ gas atmosphere for 20 hours and then slowly cooled.

Table 3 shows the changes of the orientation difference (the deviation angle, °) (α²+β²)^{1/2} with the exact {110}<001> orientation, the magnetic flux density, and the iron loss for the secondary recrystallization grain after the final high temperature annealing depending on the rolling temperature during the cold rolling.

TABLE 3

| cold rolling | (α² + β²)^{1/2} | magnetic flux | iron loss | |
|---|---|---|---|---|
| temperature (° C.) | (°) | density (Tesla) | (W/kg) | |
| 50 | 4.2 | 1.912 | 0.899 | Comparative |
| | | | | material 1 |
| 100 | 4.1 | 1.918 | 0.872 | Comparative |
| | | | | material 2 |
| 150 | 3.9 | 1.922 | 0.833 | Inventive |
| | | | | material 1 |
| 250 | 3.7 | 1.945 | 0.799 | Inventive |
| | | | | material 2 |
| 300 | 3.8 | 1.937 | 0.804 | Inventive |
| | | | | material 3 |
| 350 | 4.3 | 1.905 | 0.905 | Comparative |
| | | | | material 3 |

As shown in Table 3 above, when the cold rolling temperature is less than 150° C., and in contrast, when it is above 300° C., the orientation difference (the deviation angle, °) (α²+β²)^{1/2} with the exact {110}<001> orientation of the secondary recrystallized grain orientation was 4° or more and it is difficult to obtain the magnetic flux density of 1.92 Tesla or more.

### Exemplary Embodiment 4

In performing the decarburization and the primary recrystallization annealing using the cold-rolled sheet of invention material 2 (the composition of invention material 8 in Table 1) evaluated in the above exemplary embodiment 3, the temperature was increased by changing the temperature increasing speed according to the conditions shown in Table 4, and then the temperature was further increased to perform the decarburization and nitriding treatment at 850° C.

In the nitriding treatment, ammonia gas was used during the decarburization annealing so as to have the total nitrogen content of 200 ppm.

Subsequently, the nitriding-treated steel sheet was subjected to the secondary recrystallization high temperature annealing in a form of a coil by applying an annealing separator containing MgO as the main component.

The high-temperature annealing was performed in a mixed gas atmosphere of 75% N₂ and 25% H₂ until 1200° C., and after reaching 1200° C., it was kept in a 100% H₂ gas atmosphere for 20 hours and then slowly cooled.

Table 4 shows the changes of the orientation difference (the deviation angle, °) (α²+β²)^{1/2} with the exact {110}<001> orientation, the magnetic flux density, and the iron loss for the secondary recrystallization grain after the final high temperature annealing depending on the heating speed during the decarburization and primary recrystallization.

TABLE 4

| Heating | | | magnetic flux | | |
|---|---|---|---|---|---|
| temperature | Heating speed | | density | iron loss | |
| (° C.) | (° C./sec) | (α² + β²)^{1/2} (°) | (Tesla) | (W/kg) | |
| 550 | 30 | 4.1 | 1.916 | 0.884 | Comparative |
| | | | | | material 1 |
| 620 | 25 | 3.9 | 1.928 | 0.835 | Inventive |
| | | | | | material 1 |
| 650 | 50 | 3.8 | 1.935 | 0.813 | Inventive |
| | | | | | material 2 |
| 650 | 100 | 3.8 | 1.941 | 0.805 | Inventive |
| | | | | | material 3 |
| 650 | 200 | 3.9 | 1.932 | 0.824 | Inventive |
| | | | | | material 4 |
| 700 | 45 | 3.7 | 1.948 | 0.795 | Inventive |
| | | | | | material 5 |
| 700 | 15 | 4.2 | 1.911 | 0.899 | Comparative |
| | | | | | material 2 |

As shown in Table 4 above, in the case of increasing the temperature to a temperature of 600° C. or higher and a hearing speed with a speed of 20° C./sec or higher, it may be confirmed that the orientation difference (α²+β²)^{1/2} is 4° or less and the magnetic flux density is obtained with 1.92 Tesla or more.

This means that it is necessary to increase the heating speed to 20° C./sec or more in the temperature range of 600° C. or higher in the decarburization and primary recrystallization annealing step in order to connect the effect of the adding of the grain boundary segregation elements such as P, Sn, Sb, Ge, As, Pb, and Bi and performing the rough rolling more than once with the reduction ratio of 20% or more in the step of the rough rolling to the magnetic flux density of the final product.

Although exemplary embodiments of the present invention were described above, those skilled in the art would understand that the present invention may be implemented in various ways without changing the spirit or necessary features. Therefore, the embodiments described above are only examples and should not be construed as being limitative in any respects.

1. An oriented electrical steel sheet comprising C: 0.01% or less (excluding 0%), Si: 2.0%-4.0%, Mn: 0.01%-0.20%, acid soluble Al: 0.040% or less (excluding 0%), N: 0.008% (excluding 0%), S: 0.008% (excluding 0%), Se: 0.0001-0.008%, Cu: 0.002-0.1%, Ni: 0.005-0.1%, Cr: 0.005-0.1%, P: 0.005%-0.1% and Sn: 0.005%-0.20%, one or more among Sb: 0.0005%-0.10%, Ge: 0.0005%-0.10%, As: 0.0005%-0.10%, Pb: 0.0001%-0.10%, Bi: 0.0001%-0.10% and Mo:0.001-0.1% as wt %, and consisting of the balance of Fe and other inevitable impurities, and
after final secondary recrystallization, a magnetic flux density B8 is 1.92 Tesla or more.

2. The oriented electrical steel sheet of claim 1, wherein
an orientation difference (α²+β²)^{1/2} with an exact {110}<001> Goss texture for a secondary recrystallization grain after the final secondary recrystallization is 4° or less.

3. A manufacturing method of an oriented electrical steel sheet, comprising:
preparing a slab including C: 0.01% or less (excluding 0%), Si: 2.0%-4.0%, Mn: 0.01%-0.20%, acid soluble Al: 0.040% or less (excluding 0%), N: 0.008% (excluding 0%), S: 0.008% (excluding 0%), Se: 0.0001-0.008%, Cu: 0.002-0.1%, Ni: 0.005-0.1%, Cr: 0.005-0.1%, P: 0.005%-0.1% and Sn: 0.005%-0.20%, one or more among Sb: 0.0005%-0.10%, Ge: 0.0005%-0.10%, As: 0.0005%-0.10%, Pb: 0.0001%-0.10%, Bi: 0.0001%-0.10%, and Mo:0.001-0.1% as wt %, and consisting of the balance of Fe and other inevitable impurities;
heating the slab below 1280° C.;
performing hot rolling and hot rolled sheet annealing to the heated slab to manufacture a hot rolled sheet;
manufacturing a cold rolled sheet by cold rolling and intermediate annealing the hot rolled sheet;
heating the cold-rolled sheet to a temperature of 600° C. or higher at a temperature increasing rate of 20° C./sec or higher to perform decarburization annealing and nitriding treatment for a primary recrystallization; and
applying an annealing separator including MgO as a main component to finally anneal the primary recrystallized steel sheet for secondary recrystallization,
wherein rough rolling is performed with a cumulative reduction ratio of 60% or more and rough rolling with a reduction ratio of 20% or more is performed once or more in the slab rough rolling before the hot rolling, and the hot rolling is performed.

4. The manufacturing method of the oriented electrical steel sheet of claim 3, wherein
decarburization annealing and nitridation treatments are performed in the primary recrystallization step so as to ensure a total nitrogen content of the steel sheet of 0.01-0.05%.

5. The manufacturing method of the oriented electrical steel sheet of claim 4, wherein
the rough rolling of which the cumulative reduction ratio is 70% or more is performed in the slab rough rolling.

6. The manufacturing method of the oriented electrical steel sheet of claim 5, wherein
the cold rolling is performed in the temperature range of 150-300° C. during the cold rolling.

7. The manufacturing method of the oriented electrical steel sheet of claim 6, wherein
the cold-rolled sheet is heated to a temperature of 600° C. or higher with a heating rate of 50° C./sec or higher in the primary recrystallization annealing.
